(19) United States
(12) Patent Application Publication
(10) Pub. No.: US 2019/0034991 A1
(43) Pub. Date: Jan. 31, 2019

(54) INFORMATION INSIGHT SYSTEM FOR PROVIDERS OF PRODUCTS OR SERVICES

(71) Applicant: International Business Machines Corporation, Armonk, NY (US)

(72) Inventors: Michael Bender, Rye Brook, NY (US); Gregory J. Boss, Saginaw, MI (US); Jeremy R. Fox, Georgetown, TX (US); Rick A. Hamilton, II, Charlottesville, VA (US)

(21) Appl. No.: 15/844,988

(22) Filed: Dec. 18, 2017

Related U.S. Application Data
(63) Continuation of application No. 15/659,959, filed on Jul. 26, 2017.

(51) Int. Cl. G06Q 30/06; G06Q 50/00

(52) U.S. Cl. CPC G06Q 30/0613; G06F 19/327; G06Q 50/01

(57) ABSTRACT

A first user entering a physical location can be identified. In response, a first user profile information for the user can be accessed. The first user profile information can be compared to user profile information of a plurality of other users who are present at the physical location. Based on the comparing, at least a second user whose user profile information most closely matches the first user profile information can be identified. A notification can be communicated to a client device used by the second user, the notification notifying the second user to initiate interaction with the first user. The client device can be configured to present the notification to the second user.

### BACKGROUND

The present invention relates to data processing systems, and more specifically, to data processing systems used in retail and customer/patient servicing environments.

It is common for retailers to use point-of-sale (POS) systems in their stores. A POS system typically includes a cash register and a POS terminal. A POS terminal is used to process card payments for retail transactions. Sometimes, but not always, the POS terminal is integrated with the cash register. Many POS systems include software suites that include sale, inventory, stock counting and vender ordering modules. Such modules can simplify inventory control in the stores.

### SUMMARY

A method includes identifying a first user entering a physical location. The method also can include, responsive to identifying the first user entering the physical location, accessing a first user profile information for the first user. The method also can include comparing the first user profile information to user profile information of a plurality of other users who are present at the physical location. The method also can include, based on the comparing, identifying, using a processor, at least a second user whose user profile information most closely matches the first user profile information. The method also can include communicating a notification to a client device used by the second user, the notification notifying the second user to initiate interaction with the first user, wherein the client device is configured to present the notification to the second user.

### BRIEF DESCRIPTION OF THE DRAWINGS

FIG. 1 is a diagram illustrating an example of a physical location visited by users.

FIG. 2 is a block diagram illustrating an example of a computing environment.

FIG. 3 is a block diagram illustrating example architecture for a data processing system.

FIG. 4 is a flow chart illustrating an example of a method of notifying a user to initiate interaction with another user.

### DETAILED DESCRIPTION

This disclosure relates to data processing systems, and more specifically, to data processing systems used in retail and customer/patient servicing environments.

In accordance with the arrangements described herein, a first user (e.g., a customer or patient) entering a physical location, for example a retail store, a hotel, a restaurant or a medical facility, can be identified. In response, user profile information for the first user can be accessed. The user profile information can include not only data from a user profile of the first user, but also data from one or more other data sources, for example one or more social networking services used by the first user.

The user profile information for the first user can be compared to user profile information of a plurality of other users present at the physical location, for example sales associates, medical personnel, etc. Based on the comparison, at least a second user, whose user profile information of the first user, can be identified. A notification can be communicated to a client device used by the second user. The notification can notify the second user to initiate interaction with the first user. The interaction can include, for example, greeting the first user, and initiating a conversation pertaining to common interests and/or hobbies of the first user and the second user, for example, interests and/or hobbies not directly related to products or services provided at the physical location. Initiating such a conversation can serve to build a rapport between the first and second users, and give the first user a feeling of comfort with the second user. As the interaction proceeds, the conversation can move on to products and/or services the first user is interested in purchasing, the first user's medical ailments, etc.

Further, at least a portion of the user profile information of the first user can be communicated to the second user. In one aspect, such information can include predictive information generated by a cognitive system pertaining to purchasing interests of the user. The second user can use the information to help guide interaction with the user. For example, the second user can show to the first user the types of products in which the first user is interested. In another example, the user profile information can indicate medical ailments from which the first user is suffering, the first user's medical history, etc., and the second user can use the information to proceed efficiently with medically treating the first user.

Several definitions that apply throughout this document now will be presented.

As defined herein, the term “physical location” means a location physically located in the real world. A web site is not a “physical location” as the term “physical location” is defined herein. A web based service is not a “physical location” as the term “physical location” is defined herein. A virtual environment (e.g., a virtual world) hosted by a data processing system is not a “physical location” as the term “physical location” is defined herein.

As defined herein, the term “user profile information” means information about a user gathered from one or more information sources. The information sources can include, but are not limited to, information from a user profile of the user, information shared by the user in at least one social networking service, information about the user posted by at least one other user in at least one social networking service, sales transaction history pertaining to the user, item return history pertaining to the user, medical records of the user, and so on.

As defined herein, the term “directly related” means pertaining specifically to. For example, if a user is shopping for a home entertainment system, a conversation about sports is not directly related to the home entertainment system.

As defined herein, the term “predictive information” means information about a user that is predicted by a data processing system by analyzing information associated with the user, for example using predictive analytics.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “client device” means a processing system including at least one processor and memory that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, and the like. Network infrastructure, such as routers, firewalls, switches, access points and the like, are not client devices as the term “client device” is defined herein.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

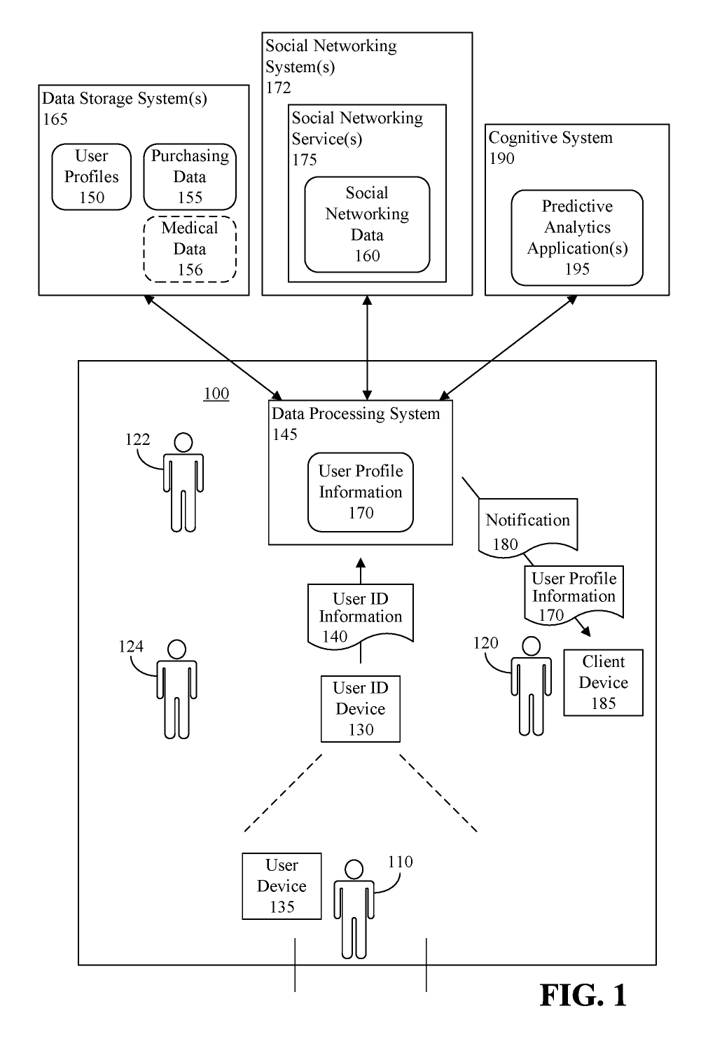

FIG. 1 is a diagram illustrating an example of a physical location 100 visited by users, for example a user 110. The physical location can be a physical store (e.g., a store within a physical structure), a hotel, a restaurant, a medical facility (e.g., hospital, emergency care facility, doctor's office, dentist's office, etc.), or any other physical structure in which the user 110 may enter and interface with one or more other users 120, 122, 124 who may provide products, services and/or information the user 110. For example, the user 110 can be a customer or a patient, and the users 120, 122, 124 can be sales associates or medical personnel, for example medical care providers. Examples of medical care providers include, but are not limited to, physicians, physician assistants, nurses, nursing assistants, dentists, dental assistants, etc.

A user identifying device 130 can be disposed within, or proximate to (e.g., within a threshold distance of), the physical location 100. The user identifying device 130 can be used to identify, automatically, user identifiers for users in response to the users entering the physical location 100. For example, in response the user 110 entering the physical location 100, the user identifying device 130 can be used to identify, automatically, a user identifier for the user 110.

In illustration, the user identifying device 130 can collect user identification data for the user 110 in response to the user 110 entering the physical location 100. In an example, the user identifying device 130 can be an access point or beacon that establishes a communication link with a user device 135 carried by the user 110. In this example, the user device 135 can be a tablet computer, a smart phone, a personal digital assistant, a smart watch, smart glasses, or the like. Responsive to a communication link being established between the user identifying device 130 and the user device 135, the user device 135 can communicate to the user identifying device 130 information that identifies the user 110, for example a user identifier of the user 110. In another example, the user identifying device 130 can be a radio frequency identification (RFID) scanner that scans RFID tags. In this example, the user device 135 can be an RFID tag. The RFID tag can be attached to or embedded in clothing worn by the user 110, attached to or embedded in another object carried by the user 110, or attached to or embedded within the body of the user 110. The RFID scanner can scan the RFID tag to receive from the RFID information that identifies the user 110, for example a user identifier of the user 110. In a further example, the user identifying device 130 can be an image capture device (e.g., a still image camera or a video camera) that captures images of the user 110 and generates corresponding image data.

The user identifying device 130 can communicate user identification information 140 to a data processing system 145, which can be located within the physical location 100, or elsewhere. The user identification information 140 can be, for example, a user identifier or image data. In the case that the user identification information 140 is image data, the data processing system 145 can process the image data to identify the user 110, for example to determine a user identifier for the user 110. In illustration, the data processing system 145 can perform facial recognition on image data representing at least one image of the user 110 that is captured, and generates first facial recognition data. The data processing system 145 or another data processing system, can match the first facial recognition data to second facial recognition data stored for the user 110. The second facial recognition data can be stored locally by the data processing system 145, for example based on previous instances of the user entering the physical location 100, or stored on another data storage system, for example a data storage system 165 to which the data processing system 145 is communicatively linked. Responsive to matching the first facial recognition data to the second facial recognition data stored for the user 110, the data processing system 145 can identify a user identifier associated with the second facial recognition data. That user identifier can be a user identifier of the user 110.

Regardless of how the user 110 is identified, the data processing system 145 can use the user identification information (e.g., user identifier) to access user profile information 170 pertaining to the user 110. The data processing system 145 can store the user profile information 170 to memory elements of the data processing system 145, at least temporarily. The user profile information 170 can include, for example, data from a user profile 150 of the user 110, purchasing data 155 for the user 110, social networking data 160 for the user 110, and so on. In an arrangement in which the physical location 100 is a medical facility, the user profile information 170 can include medical data 156 (e.g., a medical profile) pertaining to the user 110, for example a medical history of the user 110. The data processing system 145 can aggregate the collected data as the user profile information 170 for the user 110.

In a similar manner, the data processing system 145 also can collect data for the respective users 120-124 and aggregate such data as user profile information 170 for the respective users 120-124. The user profile information 170 for each of various users 120-124 can include information from their respective user profiles 150, as well as other information pertaining to the users 110-124 that is obtained, for example social networking data 160 for the respective users 120-124. The user profile information 170 for each of various users 120-124 need not include purchasing data 155 or medical data 156, however, although the present arrangements are not limited in this regard.

The data processing system 145 can access the user profile 150 and purchasing data 155 (or medical data 156) from one or more data storage systems 165, for example one or more data storage systems 165 hosting one or more databases. The data storage systems 165 can be external to the physical location 100, but this need not be the case. For instance, in one non-limiting arrangement, the data storage systems 165 can be hosted by the data processing system 145. The data processing system 145 can access the social networking data 160 from one or more social networking services 175 hosted by one or more social network systems 172. In this regard, the users 110-124 can configure their respective user profiles in the social networking service(s) 175 to indicate that the social networking service(s) 175 are authorized to share certain social networking data 160 with one or more other data processing systems, including the data processing system 145.

The user profile information 170 of each user 110-124 can include demographic information for the respective user 110-124, for example age, sex, education level, income level, marital status, occupation, etc. Further, the user profile information 170 of each user 110-124 can include information indicating interests and/or hobbies of the respective user 110-124. The interests and/or hobbies can be indicated in the respective user profiles 150 and/or the social networking data 160 for the respective users. For example, the data processing system 145 can analyze social networking data 160 of the respective users 110-124 to identify their interests and/or hobbies. The social networking data 160 can include, for example, text and/or images posted by, or communicated to, the respective users, data indicating groups in which the respective users 110-124 are members, “likes,” “dislikes,” etc. posted by the respective users 110-124, and so on.

In the case of the user 110, the user profile information 170 of the user 110 also can include purchasing patterns of the user 110 and/or product return history of the user 110 indicated in the purchasing data 155. The purchasing patterns can indicate, for example, specific products/services purchased by the user 110, types of products/services purchased by the user 110, brands of products/services purchased by the user 110, products returned by the user 110 (e.g., specific products, types of products, brands of products, etc.) and so on. In the case that the physical location 100 is a medical facility, the user profile information 170 can include medical information pertaining to the user 110 indicated in the medical data 156.

The data processing system 145 process the user profile information 170 of the users 110-124 to determine a user 120, 122, 124 who is to initiate interaction with the user 110, for example to provide sales assistance to the user, medical assistance to the user, etc. To determine which user 120, 122, 124 is to initiate interaction with the user 110, the data processing system 145 can compare the user profile information 170 of the user 110 to user profile information 170 of the respective users 120, 122, 124. Based on such comparison, the data processing system 145 can identify the user 120 whose user profile information 170 most closely matches the user profile information 170 of the user 110.

The determination of whose user profile information 170 most closely matches the user profile information 170 of the user 110 can be determined based on various parameters assigned to the user profile information 170 of the respective users 110-124. In illustration, the data processing system 145 can, based on the user profile information 170 of each user 110-124, assign parameters indicating demographic information, particular interests/hobbies of the user 110-124 indicated in the user profile information 170 for that user 110-124, etc. The data processing system 145 can determine whether any of the demographic information and/or interests/hobbies correlate with products offered for sale at the physical location 100. The data processing system 145 can assign weighting values to each parameter. In doing so, the data processing system 145 can assign to parameters indicating demographic information and/or interests/hobbies, that correlate with products offered for sale at the physical location 100, weighting values that are higher than weighting values assigned to demographic information and/or interests/hobbies that do not correlate with products offered for sale at the physical location 100.

As part of the process of comparing the user profile information 170 of the user 110 to the user profile information 170 of the users 120-124, the data processing system 145 can determine each of the assigned parameters that match between the compared user profile information 170. For each match, the data processing system can assign a weighting value to the match based on the weighting values assigned to the matching parameters. Further, for each comparison of the user profile information 170 of the user 110 to user profile information 170 of the users 120-124, the data processing system 145 can determine an overall score of the comparison. The overall score can be, for example, a sum of the weighting values assigned to the matching parameters in that comparison. The data processing system 145 can determine the comparison having the highest overall score, and select the user 120-124 (e.g., the user 120) whose user profile information 170 was used in that comparison as the user whose user profile information 170 most closely matches the user profile information 170 of the user 110.

Further, the data processing system can notify that user 120 to initiate interaction with the user 110. For example, the data processing system 145 can communicate a notification 180 to a client device 185 used by the user 120. That notification 180 can be a message indicating to the user 120 to initiate interaction with the user 110 and, optionally, can include an image of the user 110 to facilitate recognition of the user 110 by the user 120. The client device 185 can present the notification 180 to the user 120. By determining which of the plurality of users 120-124 has user profile information 170 most closely matching that of the user 110, and initiating that user 120 to interact with the user 110, the data processing system 145 can ensure an efficient and productive interaction by the selected user 120 with the user 110.

In illustration, assume that the physical location 100 is a store that sells home entertainment equipment. Also, assume that a user profile of the user 110 indicates that the user 110 is a particular age. Further, assume that social networking posts by the user 110 indicate that the user plays a bass guitar, likes a particular baseball team, and is interested in a new home entertainment system. Also, assume that the purchasing data 155 indicates that the user has previously purchased home entertainment equipment. This information can be indicated in the user profile information 170 of the user 110.

Further, assume that the user 120 is a sales associate who is approximately the same age as the user 110 (e.g., within a threshold number of years). Further, assume that the user 120 also plays bass guitar and is interested in the same baseball team in which the user 110 has interest, which can be indicated in the user profile 150 of the user 120 and/or social networking data 160 of the user 120. By comparing the user profile information 170 of the users 110, 120, the data processing system 145 can determine that both of the users 110, 120 are in the same age group, play bass guitar, and are interested in the same baseball team. Thus, the data processing system 145 can determine that the user 120 is the best choice from among the users 120-124 to assist the user 110 while the user 110 is in the store.

The data processing system 145 can communicate to the client device 185 at least a portion of the user profile information 170 of the user 110, such as information indicating interests/hobbies of the user 110. The user 120 can review this information and initiate a conversation with the user 110 related to common interests/hobbies of the users 110, 120 (e.g., bass guitars, baseball, a particular baseball team, etc.). Because both of the users 110, 120 have a common interest beyond the actual type of product in which the user 110 is interested in purchasing, or otherwise not directly related to products or services provided at the physical location 100, initiating a conversation related to such common interests can serve to build a rapport between the users 110, 120, and give the user 110 a feeling of comfort with the user 120. Thus, the likelihood of a productive shopping experience for the user 110 will be increased as opposed to a situation in which the user 120 has little in common with the first user 110.

In one aspect of the present arrangements, the portion of the user profile information 170 communicated to the client device 185 can include additional information. In illustration, the data processing system 145 can communicate to the client device 185 a list of items purchased by the user 110, for example items recently purchased, brands of items the user has purchased, a list of items returned by the user, etc. For example, if the user profile information 170 for the user 110 indicates a particular brand/model of home entertainment equipment in which the user 110 is interested, an indication of that brand/model can be included in the portion of the user profile information 170 communicated to the client device 185 of the user 120. Thus, the user 120 will be made aware of that the user 110 is interested in that home entertainment equipment. Moreover, knowing interests of the user 110 (e.g., the user plays bass guitar and watches baseball), the user 120 can show the user 110 products that are well suited for those interests (e.g., audio equipment that performs well at playing music with heavy bass guitar sounds, televisions that have features related to optimizing presentation of sports related media, etc.). Accordingly, the user 120 can facilitate the shopping experience of the user 110 by leading the user 110 directly to the type of products in which the user 110 is interested or may be interested. Such an efficient shopping process can be perceived by the user 110 as being pleasant. Accordingly, the user 110 likely will frequent the store more frequently that the user 110 otherwise would, which can result in increased sales to the user 110.

The present arrangements are not limited to physical locations that are stores. For example, the physical location can be a hotel, and the arrangements described herein can be implemented to select a bellhop who has interests and/or demographics in common with the user 110 to help the user 110. For example, assume the users 120-124 are bellhops. The data processing system 145 can determine that, from among the users 120-124, the user 120 is closest in age to the user 110 and/or has a greatest number of interests/hobbies that are in common with of interests/hobbies of the user 110. Similarly, if the physical location 100 is a restaurant, the data processing system 145 can determine a waiter or waitress (e.g., user 120) that, from among the users 120-124, is closest in age to the user 110 and/or has a greatest number of interests/hobbies that are in common with of interests/hobbies of the user 110. In one aspect, the portion of the user profile information 170 communicated to the client device 185 can include information posted by the user 110 in social media, for example, a complaint about missing a particular sporting event. The user 120 can greet the user 110 and begin a conversation related to one or more of the common interests/hobbies, or missing the sporting event, which can lead to a pleasant interaction between the user 110 and the user 120, thus giving the user 110 a favorable impression of the hotel or restaurant.

If the physical location 100 is a hospital, the data processing system 145 can determine an attendant (e.g., user 120) that, from among the users 120-124, is closest in age to the user 110 and/or has a greatest number of interests/hobbies that are in common with of interests/hobbies of the user 110. In illustration, if the user 110 is to be transported in a wheel chair or gurney, the data processing system 145 can select a user 120 from among users 120-124 that perform such duties. Again, the user 120 can greet the user 110 and begin a conversation related to one or more of the common interests/hobbies, etc. Not only can this lead to a pleasant interaction between the user 110 and the user 120, thus giving the user 110 a favorable impression of the hospital, it can help to put the user 110 at ease or in a more relaxed mood. For instance, discussing interests/hobbies not directly related to the user's hospital visit can lighten the mood of the user 110, and can be beneficial to the user 110 if the user 110 is suffering from an ailment or about to be treated with surgery, etc.

In one aspect of the present arrangements, the user profile information 170 can include predictive information. For example, the data processing system 145 can communicate at least a portion of user profile information 170 pertaining to the user 110 to a cognitive system 190 that performs predictive analytics (e.g., IBM Watson®). The cognitive system 190 can, in real time, perform predictive analytics on the received user profile information 170 and generate predictive information pertaining to the user, for example types of items and/or services the user may be interested in purchasing, an amount of money the user may be willing to spend on items/services, etc.

In a further example, performing the predictive analytics can include analyzing purchasing trends of consumers in general, and applying corresponding parameters in the analysis. For instance, if the user profile information 170 of the user 110 indicates the user frequently purchases items that are very popular with consumers in general, the predictive analytics can indicate a likelihood (e.g., a probability value) that the user 110 is interested in purchasing an item that currently is popular.

The cognitive system 190 can communicate results of the predictive analysis to the data processing system 145 as predictive information. The data processing system 145 can update the user profile information 170 of the user 110 with the predictive information, and include the predictive information in the portion of the user profile information 170 communicated to the client device 185. Accordingly, the user 120 can use the predictive information to gain insight into products/services the user 110 may be interested in purchasing.

Further, the data processing system can dynamically update the user profile 150 of the user 110 with any information contained in the user profile information 170 not already stored in the user profile 150 of the user 110. In this regard, the user profile 150 can be updated as additional user profile information 170 of the user 110 is obtained and analyzed. Such information can be can be accessed from the user profile 150 for future instances of the user 110 entering the physical location 100 or a related physical structure. For example, assume that the physical location 100 is a store that is a member of a chain of stores. The user profile 150 of the user 110 can be available for access by any of the stores in that chain responsive to the user entering such stores. Thus, such stores can access the user profile 150 to determine user profile information 170 for the user 110, in addition to accessing any other data sources described herein. In another example, assume the physical location 100 is a medical facility. The user profile 150 can be shared with other medical facilities authorized to access the user profile 150. Accordingly, user profile information 170 gathered as described herein can be shared with such other medical facilities to facilitate prompt and accurate medical treatment of the user 110.

The cognitive system 190 can execute one or more predictive analytics applications 195 to generate the predictive information. Examples of predictive analytics applications 195 that can be used include, but are not limited to, IBM Watson® Discovery Service and IBM Watson® Tradeoff Analytics. When accessing the predictive analytics application(s) 195, the data processing system 145 can provide to the predictive analytics application(s) 195 one or more queries to filter the user profile information 170, for example to identify products in which the user 110 may be interested, pricing considerations, etc.. The queries can be stored by the data processing system 145 and communicated to the predictive analytics application(s) 195 when the predictive analytics are to be performed, or stored in the cognitive system 190 and accessed by the predictive analytics application(s) 195 when the predictive analytics are to be performed. In one arrangement, the predictive analytics application(s) 195 can perform a second level of processing to refine the results obtained using the query/queries. For example, the predictive analytics application(s) 195 can identify in the results that the user 110 is interested in bass guitars, and various criteria the user has expressed in the social networking data 160, which can be captured in the results. The predictive analytics application(s) 195 can identify bass guitars that meet the criteria, and communicate the refined results to the data processing system 145. The predictive analytics application(s) 195 also can recommend to medical care providers treatment plans for treating the user 110 in the case the user 110 is a patient.

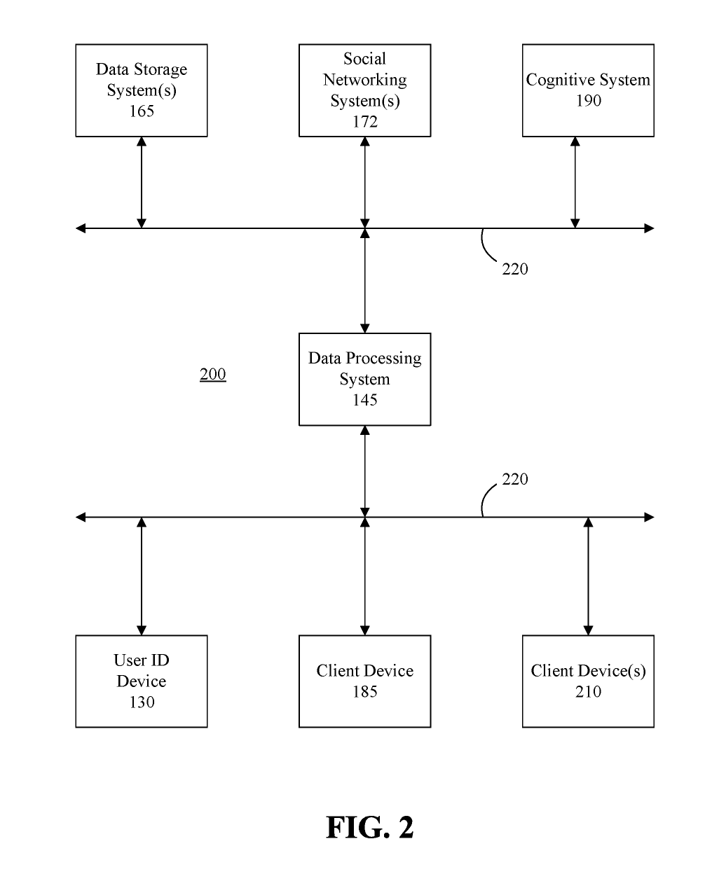

FIG. 2 is a block diagram illustrating an example of a computing environment 200. The computing environment 200 can include the various devices/systems described with respect to FIG. 1, including the user identifying device 130, the data processing system 145, the data storage system(s) 165, the social networking system(s) 172, the client device 185 and the cognitive system 190. In addition, the computing environment 200 can include one or more other client devices 210, for example client devices used by the users 122, 124 of FIG. 1.

The data processing system 145 can be communicatively linked to the user identifying device 130, the data storage system(s) 165, the social networking system(s) 172, the client device 185, the cognitive system 190 and the client devices 210 via one or more communication networks 220. A communication network 220 is the medium used to provide communications links between various devices and data processing systems connected together within the computing environment 200. The communication network(s) 220 may include connections, such as wire, wireless communication links, or fiber optic cables. The communication network(s) 220 can be implemented as, or include, any of a variety of different communication technologies such as a wide area network (WAN), a local area network (LAN), a wireless network, a personal area network (PAN), a mobile network, a Virtual Private Network (VPN), the Internet, the Public Switched Telephone Network (PSTN), or similar technologies.

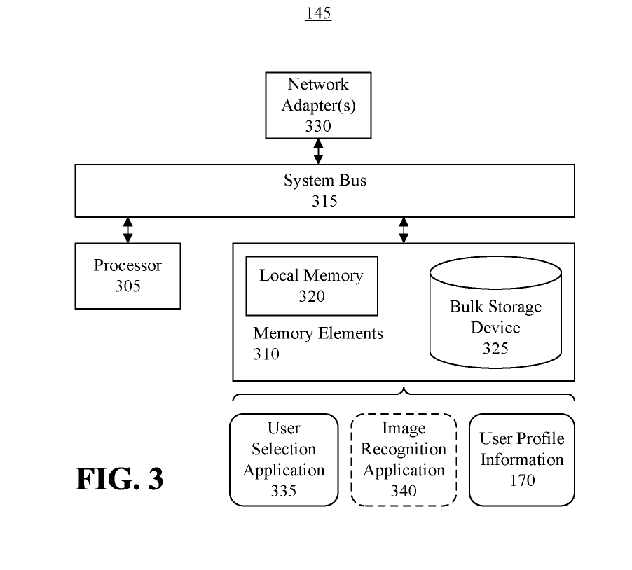

FIG. 3 is a block diagram illustrating example architecture for the data processing system 145. The data processing system 145 can include at least one processor 305 (e.g., a central processing unit) coupled to memory elements 310 through a system bus 315 or other suitable circuitry. As such, the data processing system 145 can store program code within the memory elements 310. The processor 305 can execute the program code accessed from the memory elements 310 via the system bus 315. It should be appreciated that the data processing system 145 can be implemented in the form of any system including a processor and memory that is capable of performing the functions and/or operations described within this specification. For example, the data processing system 145 can be implemented as a server, a plurality of communicatively linked servers, a workstation, a desktop computer, a mobile computer, a tablet computer, a laptop computer, a netbook computer, a smart phone, a personal digital assistant, a network appliance, and so on.

The memory elements 310 can include one or more physical memory devices such as, for example, local memory 320 and one or more bulk storage devices 325. Local memory 320 refers to random access memory (RAM) or other non-persistent memory device(s) generally used during actual execution of the program code. The bulk storage device(s) 325 can be implemented as a hard disk drive (HDD), solid state drive (SSD), or other persistent data storage device. The data processing system 145 also can include one or more cache memories (not shown) that provide temporary storage of at least some program code in order to reduce the number of times program code must be retrieved from the bulk storage device 325 during execution.

One or more network adapters 330 can be coupled to data processing system 145 to enable the data processing system 145 to become coupled to other systems, computer systems, remote printers, and/or remote storage devices through intervening private or public networks. Modems, cable modems, transceivers, and Ethernet cards are examples of different types of network adapters 330 that can be used with the data processing system 145.

As pictured in FIG. 3, the memory elements 310 can store the components of the data processing system, for example a user selection application 335 and, optionally, an image recognition application 340. Being implemented in the form of executable program code, the user selection application 335 and the image recognition application 340 can be executed by the processor 305 of the data processing system 145 and, as such, can be considered part of the data processing system 145. In addition, the memory elements 310 can store the user profile information 170. Moreover, the user selection application 335, the image recognition application 340 and the user profile information 170 are functional data structures that impart functionality when employed as part of the data processing system 145.

The user selection application 335 can access and process various data/information, such as the user profiles 150, purchasing data 155, medical data 156, social networking data 160 to perform various processes described herein as being performed by the data processing system 145. For example, the user selection application 335 can compare user profile information 170 of the user 110 to user profile information 170 of the users 120-124, select a user 120 as the user who is to interface with the user 110, communicate the notification 180 and user profile information 170 to the client device 185, and so on. The user selection application 335 can perform such processes in real time. In an arrangement in which an image capture device is used to capture one or more images of the user 110, the image recognition application 340 can process the image(s) to identify the user 110, for example by performing facial recognition on the image data. The image recognition application 340 can perform such processes in real time.

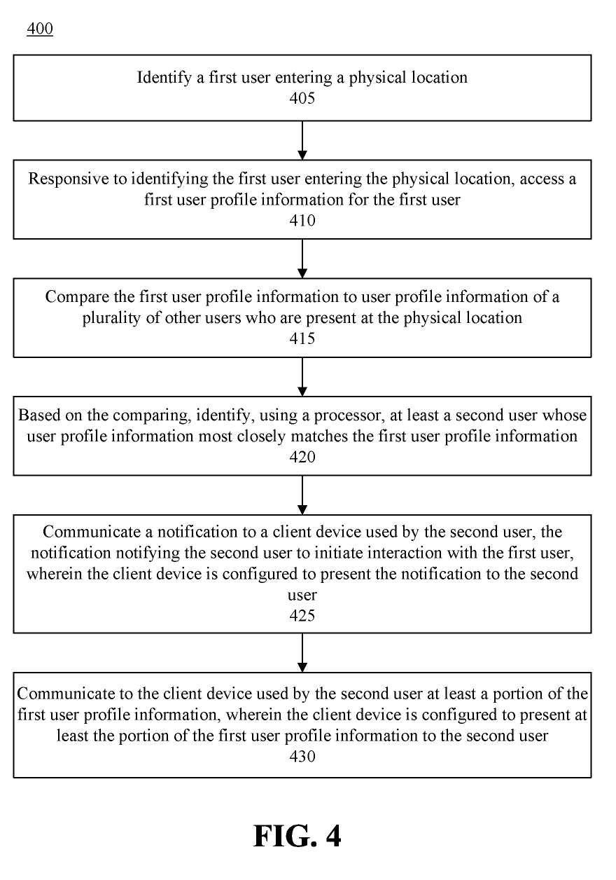

FIG. 4 is a flow chart illustrating an example of a method 400 of notifying a user to initiate interaction with another user. The method 400 can be implemented by the data processing system 145, for example by executing the user selection application 335. At step 405, the data processing system 145 can identify a first user entering a physical location. At step 410, the data processing system 145 can, responsive to identifying the first user entering the physical location, access a first user profile information 170 for the first user. At step 415, the data processing system 145 can compare the first user profile information 170 to user profile information 170 of a plurality of other users who are present at the physical location. At step 420, the data processing system 145 can, based on the comparing, identify, using a processor, at least a second user whose user profile information 170 most closely matches the first user profile information 170. At step 425, the data processing system 145 can communicate a notification to a client device used by the second user, the notification notifying the second user to initiate interaction with the first user. At step 430, the data processing system 145 can communicate to the client device used by the second user at least a portion of the first user profile information 170, wherein the client device is configured to present at least the portion of the first user profile information 170 to the second user. The data processing system 145 also can communicate any of a variety of other information to the client device used by the second user, for example predictive information pertaining to purchasing interests of the first user, medical data of the first user, and so on. Again, the client device can be configured to present such information to the second user.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if' may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
identifying a first user entering a physical location;
responsive to identifying the first user entering the physical location, accessing a first user profile information for the first user;
comparing the first user profile information to user profile information of a plurality of other users who are present at the physical location;
based on the comparing, identifying, using a processor, at least a second user whose user profile information most closely matches the first user profile information; and
communicating a notification to a client device used by the second user, the notification notifying the second user to initiate interaction with the first user, wherein the client device is configured to present the notification to the second user.

2. The method of claim 1, further comprising:
communicating to the client device used by the second user at least a portion of the first user profile information, wherein the client device is configured to present at least the portion of the first user profile information to the second user.

3. The method of claim 2, wherein:
at least the portion of the first user profile information comprises information related to at least one interest or hobby of the first user that is not directly related to products or services provided at the physical location; and
the client device is configured to notify the second user to initiate a conversation with the first user pertaining to the at least one interest or hobby of the first user.

4. The method of claim 3, wherein a second user profile information of the second user comprises information related to at least one interest or hobby of the second user that is in common with the at least one interest or hobby of the first user.

5. The method of claim 1, wherein:
the first user is a customer; and
the second user is a sales associate.

6. The method of claim 5, further comprising:
communicating to the client device used by the second user predictive information pertaining to purchasing interests of the first user, wherein the client device is configured to present the predictive information to the second user.

7. The method of claim 6, further comprising:
generating the predictive information pertaining to the purchasing interests of the first user based on at least one type of information selected from a group consisting of past purchasing patterns of the first user, product return history of the first user, current retail trends, and information shared by the first user in at least one social networking service.

8. The method of claim 1, further comprising:
automatically identifying a user identifier of the first user in response to the first user entering the physical location;
wherein the user identifier is used to access the first user profile information for the first user.

9-22. (canceled)
